(19) United States
(12) Patent Application Publication
(10) Pub. No.: US 2014/0308947 A1
(43) Pub. Date: Oct. 16, 2014

(54) Theft-prevention system for a mobile phone

(71) Applicant: Ching-Fu Chuang, Tainan City (TW)

(72) Inventor: Ching-Fu Chuang, Tainan City (TW)

(21) Appl. No.: 13/986,215

(22) Filed: Apr. 15, 2013

(51) Int. Cl. H04W 4/22

(52) U.S. Cl. CPC H04W 4/22
USPC 455/419

(57) ABSTRACT

The invention relates to a theft-prevention system for a mobile phone, primarily comprising a detection control system and a mobile phone, wherein the detection control system includes a microwave emitter, detection unit, and alarm tone, and a microwave reception unit is fit within the mobile phone, with said microwave reception unit being integrated into the mobile phone system; as a result, when the detection control system senses that someone is approaching or breaking in, it will emit a microwave signal to the microwave reception unit, while at the same time emitting an alarm tone, as well as activating the speaker of the mobile phone to notify the user indicates that someone has come within the set range, allowing the owner of the mobile phone to immediately act in response. The invention thus provides a more user-friendly, mobile phone-integrated theft-prevention system.

### BACKGROUND OF THE INVENTION

1. Field of the Invention

This invention provides a theft-prevention system for a mobile phone, more particularly the integration of a detection control system that does not require installation with a mobile phone, increasing the effectiveness of the anti-theft function and allowing the mobile phone owner to be notified immediately.

2. Description of the Prior Art

Most currently existing theft-prevention systems only sound an alarm when someone intrudes, and may require the installation of a security system. These systems are costly, and do not allow users to set them up anywhere, making them less convenient to use.

### SUMMARY OF THE INVENTION

The purpose of this invention is to provide a more convenient, easily installed theft-prevention system for a mobile phone.

The major characteristics of the invention are: it is a detection control system, comprising a microwave emitter, detection unit, and alarm tone, wherein the detection control system may be an infrared, microwave, or other detection system, and said detection unit is equipped with a selector switch. The mobile phone, said mobile phone having a microwave reception unit inside, with said microwave reception unit is linked to the mobile phone's system, and the microwave reception unit is able to receive the microwave signals sent by the microwave emitter in the detection control system.

### BRIEF DESCRIPTION OF DRAWINGS

This invention is better understood by referring to the accompanying drawings, wherein:

FIG. 1 is a block diagram of the theft-prevention system for a mobile phone in the present invention; and

FIG. 2 is a perspective view of the theft-prevention system for a mobile phone in using condition in the present invention.

### DETAILED DESCRIPTION OF THE PREFERRED EMBODIMENT

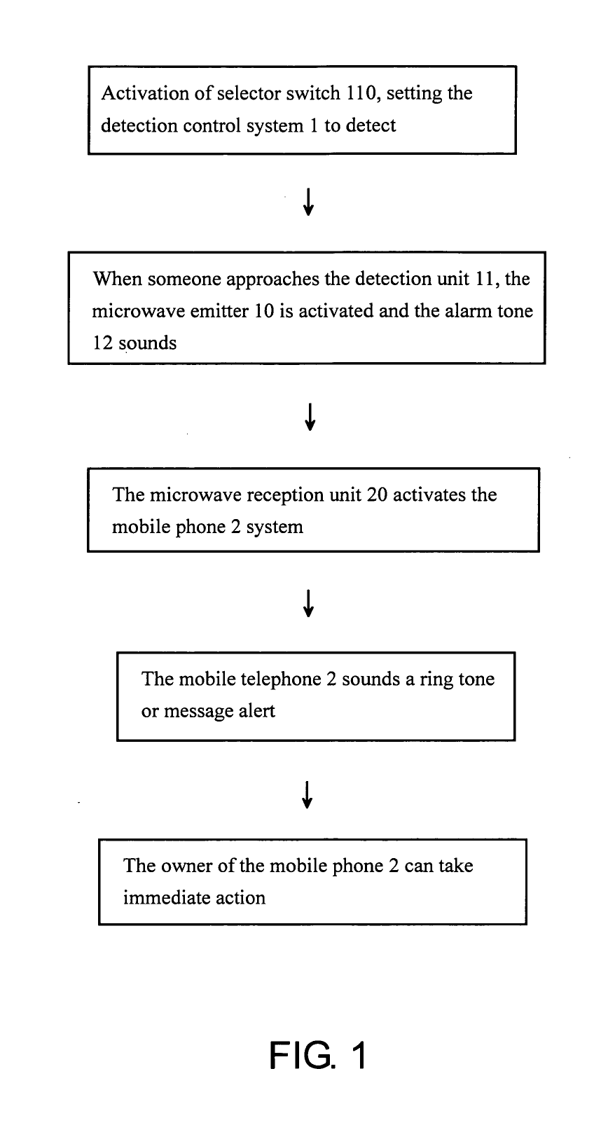

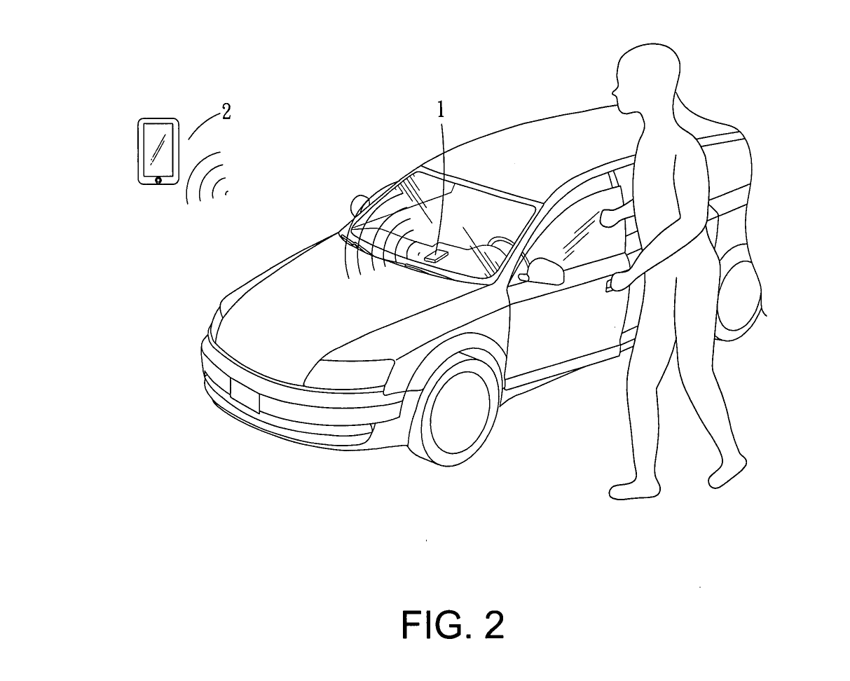

As shown in FIGS. 1 to 2, a preferred embodiment of a theft-prevention system for a mobile phone in the present invention includes a detection control system 1 and a mobile phone 2.

The detection control system 1 is comprised of a microwave emitter 10, detection unit 11, and alarm tone 12, with said detection unit 11 being an infrared ray, microwave sensor, or other detection system. The detection unit 11 is equipped with a selector switch 110.

The mobile phone 2 has a microwave reception unit 20 inside. The microwave reception unit 20 is connected to the system of the mobile phone 2, and is set to the same frequency as the microwave emitter 10 in the detection control system 1. As a result, when the microwave emitter 10 emits microwaves, they can be received by the microwave reception unit 20 in the mobile phone 2.

When using the system, the user need only place the detection control system 1 in the space or automobile where he or she desires an alarm and activate the selector switch 110, at which time the alarm system will be activated within the space. An intrusion will activate the detection unit 11, while the detection unit 11 links in turn to the microwave emitter 10 to emit microwaves while also activating an alarm tone 12. At this time, the microwave reception unit 20 in the user's mobile phone 2 will receive the microwaves from the detection unit 11, activating the mobile phone system 2 and allowing the user to immediately receive a message about the intrusion and take all necessary countermeasures.

Also, the detection control system 1 of the preferred embodiment is designed to be an electronic circuit device so the construction of an additional circuit is not needed, making use very convenient; in addition, the intervals between warnings can be changed to suit user needs, making use of the device more flexible.

The invention has the following advantages as can be seen from the foresaid description.

1. The theft-prevention system for a mobile phone in the present invention is highly convenient to use, and does not require the installation of complex wiring or a core system.

2. The theft-prevention system for a mobile phone in the present invention can immediately send an alarm signal and sound an alarm tone, thereby providing a better theft-prevention system.

While the preferred embodiment of the invention has been described above, it will be recognized and understood that various modifications may be made therein and the appended claims are intended to cover all such modifications that may fall within the spirit and scope of the invention.

What is claimed is:

1. A theft-prevention system for a mobile phone, including:
a detection control system, comprising a microwave emitter, detection unit, and alarm tone, wherein the detection control system may be an infrared ray, microwave sensor, or other detection system, and said detection unit is equipped with a selector switch;
a mobile phone, said mobile phone having a microwave reception unit inside; said microwave reception unit is linked to the mobile phone's system; said microwave reception unit is able to receive the microwave signals sent by said microwave emitter in said detection control system; and
which, through the combination of the above components, does not require complex circuit design/construction but can provide more timely intrusion alarm messages and emit an alarm sound.
